(19) United States
(12) Patent Application Publication
(10) Pub. No.: US 2008/0278446 A1
(43) Pub. Date: Nov. 13, 2008

(54) MULTI-SENSOR USER INPUT DEVICE FOR INTERACTIVE PROGRAMS ON A MACHINE

(76) Inventor: Ilan SCHIFTER, Astoria, NY (US)

Correspondence Address: HUGHES HUBBARD & REED LLP, ONE BATTERY PARK PLAZA, NEW YORK, NY, 10004, US

(21) Appl. No.: 12/116,096

(22) Filed: May 6, 2008

Related U.S. Application Data
(60) Provisional application No. 60/927,972, filed on May 7, 2007.

(51) Int. Cl. G09G 5/08; G09G 5/00

(52) U.S. Cl. 345/158; 345/156

(57) ABSTRACT

A user input device is provided for a machine having an interactive program and signals for a humanly-perceptible output for said program to allow a user in an inflatable physical structure to interact or perceive the output. The user input device includes one or more physical structures forming an enclosure adapted to accommodate and substantially laterally surround the body of at least one human user of the machine, a plurality of input elements which are disposed on the physical structure in three dimensions, wherein at least one of the input elements does not lie on the same horizontal or vertical plane on which others of said input elements lie, relative to the possible locations of the user so to be accessible to the user by unseated body movement of the user, and an interface between the input elements and the machine for providing inputs from the input elements to the interactive program.

### CROSS-REFERENCE TO RELATED APPLICATIONS

This application claims the benefit of the filing date of U.S. Provisional Patent Application Ser. No. 60/927,972 filed on May 7, 2007, the entire disclosure of which is incorporated herein by reference.

### BACKGROUND OF THE INVENTION

1. Field of the Invention

The present invention is in the field of interactive media, and more particularly relates to physical structures that provide multi-sensor user input devices for interactive programs on a machine.

2. Description of the Related Art

Structures that children and others can enter have been used for recreation interaction for many years. They are often built in the shapes of pools, castles, bouncers, sliders, furniture, boats, animals, etc. and used to entertain kids and adults for recreation purposes. Conventionally, however, such structures do not provide any input elements to allow a human user to interact with a machine-based interactive program, such as a computer program, from within or about such structure. Therefore, to enable a range of such new uses, it is desirable to provide structures of such a nature adapted to provide such inputs.

### SUMMARY OF THE INVENTION

To provide for the new uses envisioned by the foregoing, which are not provided for in the prior art, a primary object of the present invention is to provide recreational structures with user input devices for allowing a user to interact with a machine-based interactive program from within or about such structure. Another object of the present invention is to provide a user input device for allowing a user to perceive humanly-perceptible output, such as an audiovisual display, responding according to the data from the user input device. Another object of the present invention is to provide a user input device for allowing a user to spatially interact with a machine-based interactive program.

According to one embodiment of the present invention, there is provided a multi-sensor user input device for a machine providing an interactive program and signals for a humanly-perceptible output in order to allow a user to interact with the program and/or perceive the output. In such embodiment, the user input device includes one or more physical structures in three dimensions, adapted to accommodate and substantially laterally surround one or more human user, a plurality of input elements disposed within the physical structure in positions not in the same horizontal or vertical planes relative to the possible locations of the user, so as to be accessible to the user by unseated body movement, and an interface between the input elements and the machine for providing inputs from the input elements to the interactive program. In other embodiments of the invention, the physical structure of the input device may be an inflatable pen comprising four walls and a floor. Other embodiments provide for access to controls by translational body movement. Furthermore, the input elements may be paired with RFID tags to facilitate identification of the input elements, the user may use RFID tags to trigger input elements in different planes, and the input device may further provide additional output elements.

Other aspects and advantages of the invention will be apparent from the accompanying drawings, and the detailed description that follows.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 illustrates one embodiment of the present invention.

FIG. 2 illustrates another embodiment of the present invention having an inflatable pen.

FIG. 3 illustrates another embodiment of the present invention having input elements associated with physical patches attachable to the physical structure.

FIG. 4 illustrates another embodiment of the present invention having a plurality of input elements associated with RFID tags.

FIG. 5 illustrates another embodiment of the present invention having a plurality of input elements, RFID tags and patches.

FIG. 6 illustrates another embodiment of the present invention having a plurality of input elements and output elements.

### DETAILED DESCRIPTION OF PREFERRED EMBODIMENTS

The following is a detailed description of certain embodiments of the invention chosen to provide illustrative examples of how it may preferably be implemented. The scope of the invention is not limited to the specific embodiments described.

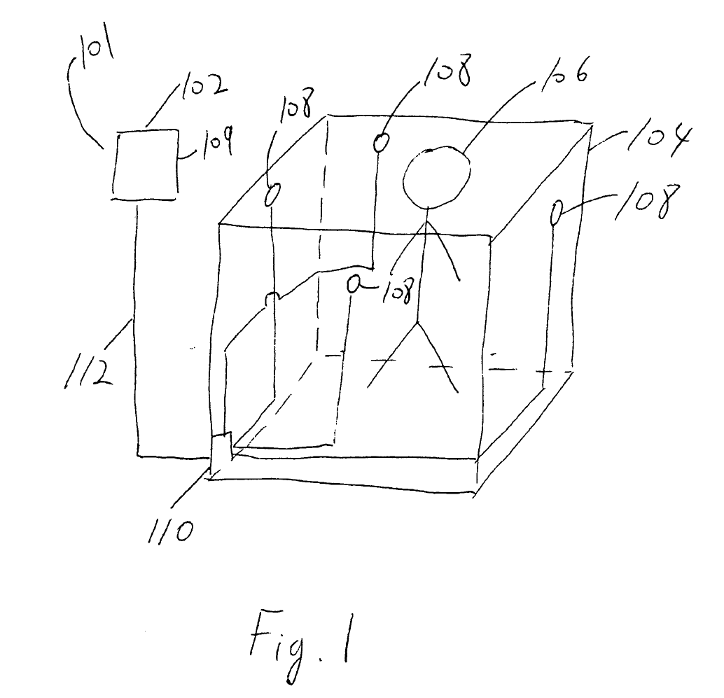

FIG. 1 shows one embodiment comprising a user input device 101 for a machine 102 providing an interactive program and signals for a humanly-perceptible output, in this particular embodiment an audiovisual display 109, for the program (which may incorporate audio as well as video outputs). The humanly-perceptible output may also be sounds, light, motion, vibrational output or any other type of outputs perceptible by a human user. The user input device includes one or more physical structures 104, a plurality of input elements 108 disposed at various locations on physical structure 104 and an interface 110 which in this embodiment is incorporated within physical structure 104. Physical structure 104 is adapted to accommodate the body of a least one human user 106. In particular, the physical structure 104 forms an enclosure that substantially laterally surrounds the user 106. Human user 106, from or in physical structure 104, may view the audiovisual display 109 provided by machine 102. Examples of the machine 102 include game consoles, personal digital assistants, mobile phones, set-top boxes, microcontrollers or any other hardware, regardless of whether external to or embedded within physical structure 104, that uses a processor to run a program and has or is connected to an output, such as a screen, speakers, etc., capable of displaying an audiovisual display or otherwise generating signals to drive, control or trigger humanly perceptible outputs. The machine 102 may also be capable of collecting data from interface 110, and communicating and controlling other interfaces, sensors, and outputs that can be added in other embodiments of the invention, such as mice, keyboards, cameras, microphones, printers, scanners, lights, speakers, platform controls, vibration devices, etc. The size and shape of the physical structure 104 may depend on the nature of the interactive program of the machine 102 and/or the size or age of the user 106.

Input elements 108 are disposed on physical structure 104 in three dimensions relative to the possible locations of user 106 within physical structure 104 and accessible to user 106 by the unseated body movement of user 106. In this embodiment, the user 106 can access the input elements 108 with his or her spatially translational body movement. The three-dimensional aspect of the disposition of input elements 108 is such that, in this embodiment, the locations of the input elements 108 are not all coplanar, meaning that at least one of the input elements 108 does not lie in the same horizontal or vertical plane on which other input elements 108 lie. Thus, physical structure 104 along with input elements 108 create an environment that substantially surrounds the user and produces a spatial experience when user 106 uses the input elements 108 to interact with the program of machine 102.

In another embodiment (not shown), the physical structure 104 may be sized so that all input elements are within reach of user 106 without translational body movement, and in which RFID tags are attached to the user or an object that the user holds or wears, and used to interact with RFID sensors disposed in three dimensions relative to the user, i.e., input elements 108 are not all coplanar, meaning, as in previously discussed embodiments, that at least one of the input elements 108 does not lie in the same horizontal or vertical plane on which other input elements 108 lie. However, in this particular alternate embodiment, unlike the other embodiments discussed herein, the user might be either seated or unseated.

In this embodiment, interface 110 is disposed between input elements 108 and machine 102 for providing inputs from input elements 108 to the interactive program. The interface 110 may be a device having its own memory and capable of running custom programs, such as external computer (which may or may not be part of the machine 102 driving the user application), microcontrollers and computer-on-a-chip systems such as PICAXE controllers. The interface 110 can also be a device-embedded solution (for example, contained within physical structure 104) such as a peripheral interface controller chip, an HID device controller chip or device, in any case having a wired or cabled (e.g. USB, serial, parallel, network, optical, etc.) connection, a wireless (e.g. Bluetooth or WiFi) connection, or any other variations thereon (including custom interconnections) that provide for input elements 108 to be able to transfer input signals to machine 102. In addition, input elements 108 may (as suitable) be connected with analog electrical connections to interface device 110, which may include A/D interfaces if necessary. The data handled by interface 110, such as the data from input elements 108, can be represented in an encoding scheme, which can be a standard input device encoding (such as HID) or a custom encoding protocol, and the encoded data can be packaged in data frames or packets, such as IP packets under the TCP/IP protocol. To the extent interfaces such as HID and protocols such as TCP/IP are employed, interface 110 will be capable of encoding and decoding data in compliance with the applicable standards and/or specifications. Interface 110 can be electronically similar to a game controller for a console or computer game, with its plurality of inputs adapted to interoperate with inputs such as inputs 108. Alternatively, all of the electronics for both interface 110 and machine 102 could be completely integrated in one small, embedded chip or package.

In the embodiment shown in FIG. 1, there is a cabled connection 112 disposed between machine 102 and interface 110 for signal transmission. Input elements 108 are connected to interface 110 through the wires incorporated within or disposed outside physical structure 104.

Input elements 108 can be any suitable transducers or devices for generating inputs for use by an interactive machine. Among the possible transducers and devices for this purpose are 1) switches, 2) RFID readers and/or sensors, 3) proximity detectors, 4) force detectors, 5) light sensors, 6) touch sensors, 7) charge-transfer sensors, 8) acceleration sensors, 9) tilt sensors, 10) motion detectors, 11) piezoelectric sensors, and 12) strain gauges. For some further examples of input transducers or devices that may be used as input elements 108, see generally Fraden, “Handbook of Modern Sensors: Physics, Designs and Applications,” Springer, third ed. 2003; Sinclair, “Sensors and Transducers,” Newnes, third ed. 2001; the category “Computing input devices” on Wikipedia.org, available at http://en.wikipedia.org/wiki/Category:Computing_input_devices; and the Wikipedia article on “Radio-frequency identification,” available at http://en.wikipedia.org/wiki/Rfid.

As an example of the operation of the present invention, the input elements 108 may be proximity detectors that are activated when the user 106 places any part of his or her body near the detectors. When a detector is activated in this manner, data is sent to the interface 110, which communicates with the interactive program of the machine 102. The interface 110 may receive data from the input elements 108 by constantly scanning the signals coming from the input elements, a process known as “polling.” Of course interrupt and other input acquisition techniques well known to persons of ordinary skill in computer interfacing may also be used. The interface 110 then sends the data corresponding to the activated inputs to the interactive program of machine 102 via connection 112, and the machine 102 will then display a particular humanly-perceptible output associated with the particular data from the input elements 108, for the user 106. More than one user may be allowed in structure 104, in which case it may be advantageous to provide for the input elements 108 to be assigned to or recognize the individual users (such as with RFID tags on an element (e.g., toy weapon, wristband, etc.) that the respective users hold or wear).

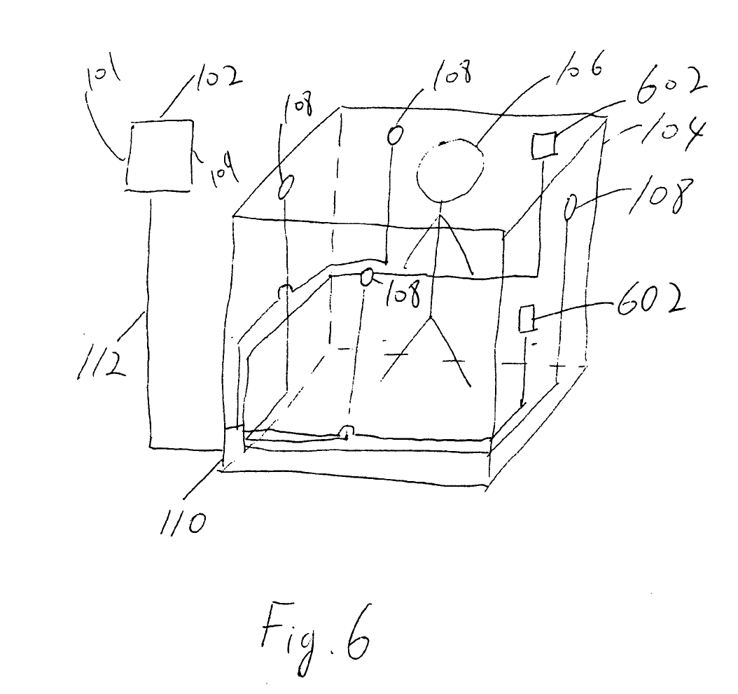

The interface 110 may also be capable of performing certain data processing functions such as filtering noise from the data from the input elements 108 and converting the analog data from input elements 108 to digital data. The interface 110 may also be capable of having a program or electronic functionality to control input elements 108. For example, the interactive program of machine 102 may send reconfiguration commands to the interface 110 and in turn the interface 110 may reconfigure the input elements 108 according to those reconfiguration commands, or send data to output elements associated with, or in proximity to, the input elements, as discussed below in connection with FIG. 6.

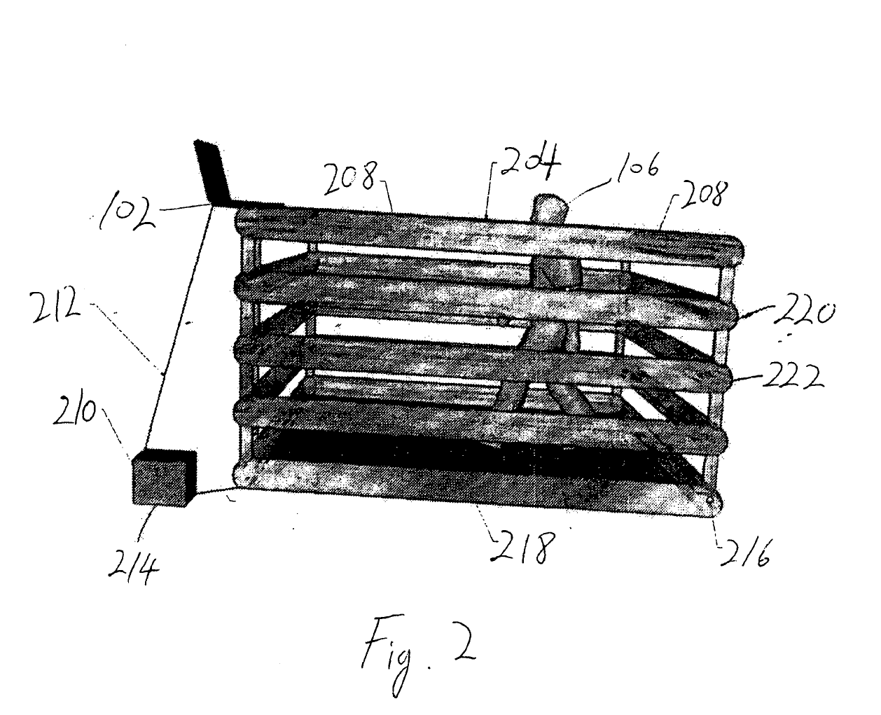

FIG. 2 represents another possible embodiment of the invention, comprising a physical structure in the form of an inflatable pen 204 including four walls 220 and a floor 218 attached to walls 220. In a variation of that embodiment, the inflatable pen 204 may not have a floor 218. In another variation of the embodiment, the inflatable pen 204 may have a roof attached to the walls 220. The set of walls 220 comprises a plurality of cylindrical elements 222 having a space between at least two of the cylindrical elements so as to allow user 106 to enter and exit inflatable pen 204. Other configurations may of course be used to provide user access. In the particular embodiment shown in FIG. 2, the set of walls 220 is comprised of four cylindrical elements 222 with spaces between each cylindrical element 222. The set of walls 220 have a surrounding top surface having a height approximately equal to user 106's eye level. The limited wall height in this embodiment is so to facilitate user 106's viewing of the audiovisual display 109. The side of floor 218 can be greater or less in length than user 106's arm span, to allow the user 106 to move about within inflatable pen 204 or to restrict the movement of the user 106. Inflatable pen 204 further includes one or more air valves 216 for inflation and deflation. In conjunction or in alternative to air valves 216, the inflatable pen 204 may have one or more air pumps for pumping air into the inflatable pen 204 and maintain the air pressure inside the inflatable pen 204. Inflatable pen 204 is inflatable and can be made of nylon to hold air and be made waterproof. In the embodiment shown in FIG. 2, there is a plurality of input elements 208 disposed inside inflatable pen 204, and an interface 210 in a waterproof housing 214 placed outside inflatable pen 204. The input elements 208 may be disposed on the walls 220, the floor 218, or a roof (not shown in FIG. 2) of the inflatable pen 204.

There is a connection 212 disposed between machine 102 and interface 210. The connection between machine 102 and interface 210 can be a cabled, network or wireless connection as discussed above in connection with the corresponding interface 110 of FIG. 1. The connection between input elements 208 and interface 210 can also be a wired, network or wireless connection as previously discussed. In another embodiment of the invention, the inflatable pen 204 may not be a structure surrounding the user 106. Rather, it may be one or more inflatable or other objects placed in proximity to the user 106.

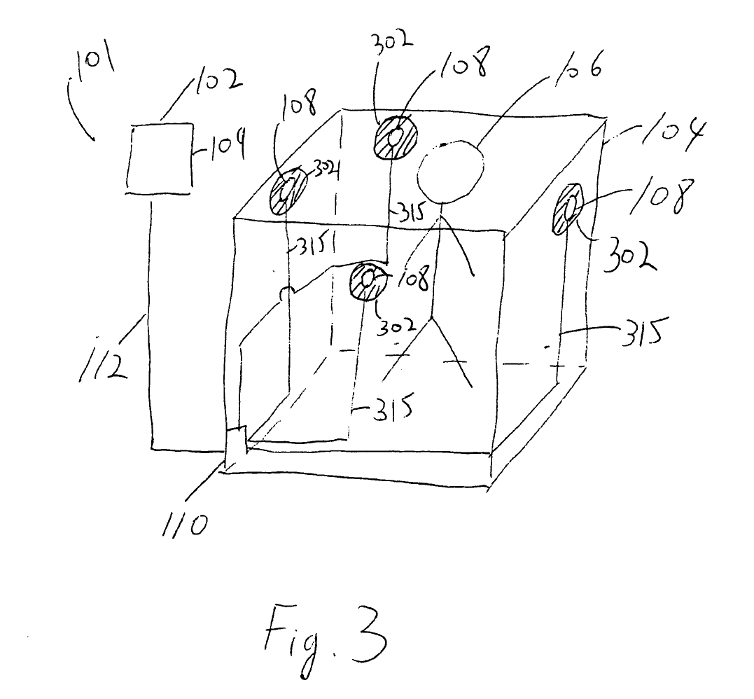

FIG. 3 shows an embodiment in which one or more input elements 108 disposed on the surface of physical structure 104 are associated with physical patches 302 attachable to physical structure 104. Input elements 108 are connected to interface 110 through wires 315 incorporated within or disposed on the surface of physical structure 104. In this embodiment, there is a cabled connection 112 disposed between machine 102 and interface 110 for signal transmission. As an example of operation of this embodiment, the audiovisual display 109 of the machine 102 may be used to relate a story or game having several characters and an image of various characters may be drawn on a different patches 302, which may each be placed on or near the respective particular input elements 108, which in this example are a plurality of touch sensors. The user 106, in order to interact with the audiovisual display 109, touches the appropriate patch 302, activating the corresponding input element 108, so that machine 102 displays an audiovisual display of a story of the character drawn on that particular patch 302 (or displays some other corresponding programming or action). In another example, the interactive program of machine 102 may be a fighting game where the user 106 must come into contact with, e.g., punch or kick, an appropriate patch 302 in order to interact with the program, e.g., fight a virtual opponent displayed by machine 102.

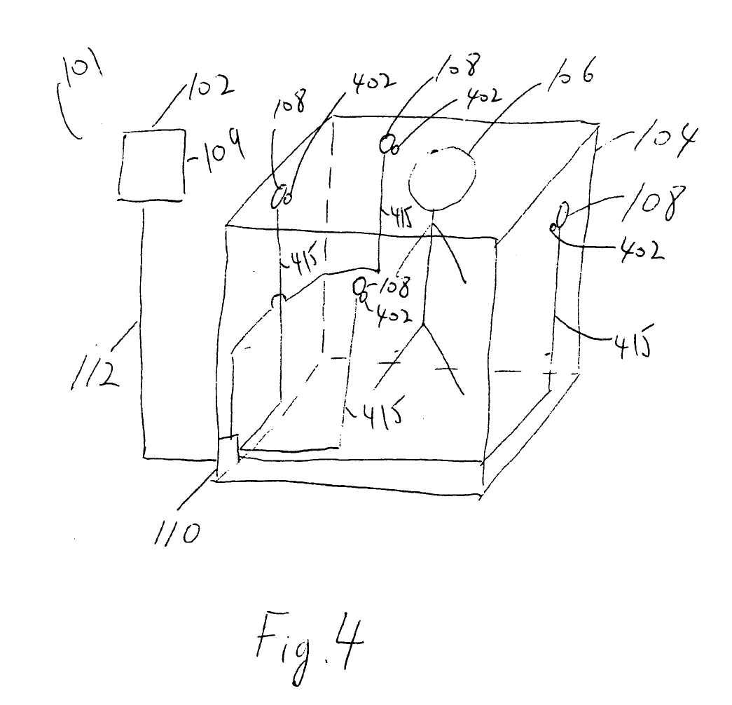

FIG. 4 shows a further embodiment in which one or more input elements 108 have RFID sensing capability and are associated with one or more RFID tags 402. An additional feature may be provided in which the association between input elements 108 and RFID tags 402 can be changed, for example by user 106. In this embodiment, input elements 108 are connected to interface 110 through the wires 415 incorporated within or disposed on the surface of physical structure 104. Again, in this embodiment there is a cabled connection 112 disposed between machine 102 and interface 110 for signal transmission. As discussed in connection with FIG. 1, input devices 108 may be configured to be assigned to or to recognize individual users where there is more than one user. RFID tags may be used for this function as well.

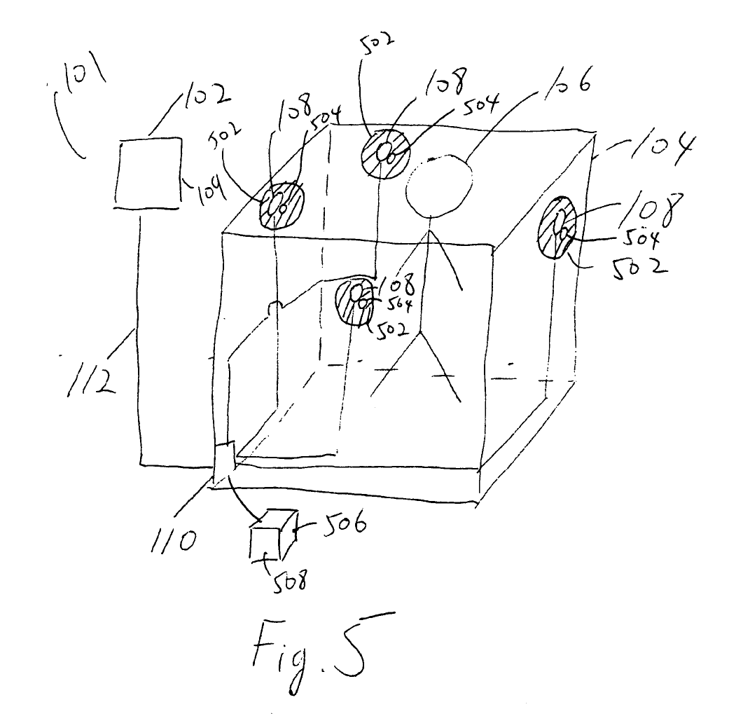

FIG. 5 shows another embodiment in which one or more input elements 108 are associated with one or more RFID tags 504, each attached to one of a plurality of patches 502. The input elements 108 can comprise RFID readers for reading the tags 504 and also include other types of sensors, such as touch, proximity, etc. sensors, as discussed above. An additional feature may be provided in which the association between the various input elements 108 and the various RFID tags 504 (and their attached patches 502) can be changed, for example by user 106. This can be accomplished when the user 106 moves the patches 502 and attaches them to various locations near input elements 108 on the physical structure 104. One of input elements 108 is a RFID sensor 506 which may be contained in a housing 508 and not attached to physical structure 104. The RFID sensor is capable of receiving information from the RFID readers embedded in other input elements 108 and passing on corresponding signals to interface 110 (or alternatively, the functionality within housing 508 as shown in FIG. 5 may be incorporated within interface 110 and housing 508 eliminated). Housing 508 is waterproof. The RFID sensor 506 can be configured by the interactive program of machine 102 to recognize a default association between a particular patch 502 having a particular RFID tag 504, with a particular input element 108. An example of an operation of this embodiment of the present invention is when the interactive program of machine 102 is a memory feedback game. At the beginning of the game, the interactive program randomly makes associations between each input element 108 and each patch 502. In this example, input elements 108 contain a plurality of proximity detectors. The user 106 then must place a particular patch 502 at an appropriate location of the physical structure 104, near the input element 108 associated with that patch 502. When patch 502 is placed near input element 108, the pairing is detected by RFID sensor 506 and the pairing data is sent from RPID sensor 506 to interface 110. If the user 106 correctly or incorrectly associates the patch 502 with input element 108, the machine 102 can provide audiovisual display indicating that the user was correct or incorrect. In another embodiment, the RFID tags 504 may not be attached to patches but rather attached to appendages of the user 106 or attached to an object held or worn by the user 106, such as a toy or a bracelet. In this embodiment, the user 106 can interact with the interactive program of the machine 102 by holding an appendage (or the held or worn object) near input elements 108.

FIG. 6 shows a further embodiment in which the user input device 101 further comprises one or more output elements 602. These output elements 602 can be disposed within or on physical structure 104 or be incorporated within or placed near interface 110. Output elements 602 can be any suitable output transducers, such as light emitting diodes, vibrating motors, inflatable structures, speakers, etc. For some further examples of output transducers that may be used as output elements 602, see generally Sinclair, “Sensors and Transducers,” Newnes, third ed. 2001. The output elements 602 may or may not be associated or integrated with one or more of the input elements 108. The output elements can be controlled by (and/or be responsive to) the interface 110, the interactive program of the machine 102, or the input elements 108. In one embodiment, the output elements 602 can be controlled by the interface 110 through a decoding of signals transmitted to the interface from machine 102 in accordance with a transmission protocol, such as the HID protocol. In that case, the interface 110 may comprise an HID device controller or comparable embedded devices.

The present invention provides various advantages over conventional recreational structures. For example, one advantage is to provide a user input device for allowing a user to interact with a machine-based interactive program. Another advantage is to provide a user input device for allowing a user to view an audiovisual display according to the data from the user input device. Yet another advantage is to provide a user input device for allowing a user to spatially interact with a machine-based interactive program.

Thus, it is apparent that there has been provided, in accordance with the present invention, a multi-sensor user input device for interactive programs on a machine that satisfies the objects of the invention set forth above.

Although the present invention has been described in detail, it should be understood that various changes, substitutions, and alterations may be readily ascertainable by those skilled in the art and may be made herein without departing from the spirit and scope of the present invention as defined by the following claims.

What is claimed is:

1. A user input device for a machine, said machine providing an interactive program and signals for a humanly-perceptible output for said program, said user input device comprising:
a) one or more physical structures forming an enclosure adapted to accommodate and substantially laterally surround the body of at least one human user of said machine and from which said user may perceive said output;
b) a plurality of input elements disposed on said physical structure in three dimensions, wherein at least one of said input elements does not lie on the same horizontal or vertical plane on which others of said input elements lie, relative to the possible locations of said user within said structure and accessible to said user by unseated body movement of said user; and
c) an interface between said input elements and said machine for providing inputs from said input elements to said interactive program.

2. The user input device of claim 1, wherein said output is an audiovisual display.

3. The user input device of claim 1, wherein said physical structure is inflatable.

4. The user input device of claim 3, further comprising one or more air valves for inflation and deflation.

5. The user input device of claim 3, further comprising one or more air pumps.

6. The user input device of claim 3, wherein said physical structure is an inflatable pen comprising four walls.

7. The user input device of claim 6, further comprising a floor attached to said walls.

8. The user input device of claim 6, further comprising a roof attached to said walls.

9. The user input device of claim 6, wherein said physical structure is made of nylon.

10. The user input device of claim 6, wherein each said wall further comprises a plurality of cylindrical elements having a space between at least two cylindrical elements so to allow said user to enter and exit said inflatable pen.

11. The user input device of claim 6, wherein each said wall has a height approximately equal to said user's eye level.

12. The user input device of claim 6, wherein said floor's side is greater in length than said user's arm span.

13. The user input device of claim 6, wherein said floor's side is less in length than said user's arm span.

14. The user input device of claim 1, wherein said input elements are disposed outside said physical structure.

15. The user input device of claim 1, wherein said input elements are disposed inside said physical structure.

16. The user input device of claim 1, wherein said input elements are selected from the group consisting essentially of (1) switches, (2) RFID sensors, (3) proximity detectors, (4) force detectors, (5) light sensors, (6) touch sensors, (7) charge-transfer sensors; (8) acceleration sensors, (9) tilt sensors, (10) motion detectors, (11) piezoelectric sensors, and (12) strain gauges.

17. The user input device of claim 1, wherein said physical structure can accommodate the bodies of more than one user, and wherein each of said input elements is associated with one or more users.

18. The user input device of claim 1, wherein one or more of said input elements is associated with a physical patch attachable to said physical structure.

19. The user input device of claim 1, wherein one or more of said input elements is associated with an RFID tag.

20. The user input device of claim 19, wherein said physical structure can accommodate the bodies of more than one user, and wherein each of said RFID tags is associated with one or more users.

21. The user input device of claim 19, wherein said RFID tag is attached to a physical patch attachable to said physical structure.

22. The user input device of claim 21, wherein said association between said input elements and said RFID tags can be changed by a user.

23. The user input device of claim 19, wherein one of said input elements is an RFID sensor contained in a housing not attached to said physical structure, and capable of identifying said RFID tags associated with said input elements.

24. The user input device of claim 23, wherein said housing is waterproof.

25. The user input device of claim 1, wherein said interface is incorporated within said physical structure.

26. The user input device of claim 1, wherein said interface is contained in a housing not incorporated in said physical structure.

27. The user input device of claim 26, wherein said housing is waterproof.

28. The user input device of claim 1, wherein said interface is capable of polling said input elements to collect data from said input elements.

29. The user input device of claim 1, wherein said interface is capable of filtering noise from said inputs.

30. The user input device of claim 1, wherein said interface is capable of converting said inputs to digital signals.

31. The user input device of claim 1, wherein said interface is capable of controlling said input elements.

32. The user input device of claim 1, wherein said interface is capable of encoding inputs from said input elements into a data transmission in compliance with a transmission protocol.

33. The user input device of claim 32, wherein said protocol is the HID protocol and said interface comprises a HID device controller.

34. The user input device of claim 1 wherein said interface has a cabled connection to said machine.

35. The user input device of claim 1 wherein said interface has a network connection to said machine.

36. The user input device of claim 1 wherein said interface has a wireless connection to said machine.

37. The user input device of claim 1, further comprising additional output elements.

38. The user input device of claim 37, wherein said additional output elements comprise light emitting diodes.

39. The user input device of claim 37, wherein said additional output elements comprise vibrating motors.

40. The user input device of claim 37, wherein said additional output elements comprise inflatable structures.

41. The user input device of claim 37, wherein said additional output elements comprise speakers.

42. The user input device of claim 37, wherein at least one of said additional output elements is controlled by said interface.

43. The user input device of claim 37, wherein at least one of said additional output elements is controlled by said machine.

44. The user input device of claim 37, wherein at least one of said additional output elements is controlled by said input elements.

45. The user input device of claim 42, wherein said control by said interface comprises a decoding of signals transmitted to said interface from said machine in accordance with a transmission protocol.

46. The user input device of claim 45, wherein said protocol is the HID protocol and said interface comprises a HID device controller.

47. A user input device for a machine, said machine providing an interactive program and signals for a humanly-perceptible output for said program, said user input device comprising:
a) one or more physical structures forming an enclosure adapted to accommodate and substantially laterally surround the body of at least one human user of said machine and from which said user may perceive said output;
b) a plurality of input elements disposed on said physical structure in three dimensions, wherein at least one of said input elements does not lie on the same horizontal or vertical plane on which others of said input elements lie, relative to the possible locations of said user within said structure and accessible to said user by spatially translational body movement of said user; and
c) an interface between said input elements and said machine for providing inputs from said input elements to said interactive program.

48. A user input device for a machine, said machine providing an interactive program and signals for a humanly-perceptible output for said program, said user input device comprising:
a) one or more physical structures forming an enclosure adapted to accommodate and substantially laterally surround the body of at least one human user of said machine and from which said user may perceive said output;
b) a plurality of input elements disposed on said physical structure in three dimensions, wherein at least one of said input elements does not lie on the same horizontal or vertical plane on which others of said input elements lie, relative to the possible locations of said user within said structure and accessible to said user by body movement of said user, and wherein said input elements comprises RFID sensors capable of detecting RFID tags attached to said user or attached to an object held or worn by said user; and
c) an interface between said input elements and said machine for providing inputs from said input elements to said interactive program.
